(19) United States
(12) Patent Application Publication
(10) Pub. No.: US 2025/0322198 A1
(43) Pub. Date: Oct. 16, 2025

(54) RFID TAG ASSEMBLY AND OBJECT TO BE IDENTIFIED INCLUDING RFID TAG ASSEMBLY

(71) Applicant: SHUYOU (SHANGHAI)TECHNOLOGY CO., LTD., Shanghai (CN)

(72) Inventor: Youngdo KIM, Shanghai (CN)

(21) Appl. No.: 19/248,102

(22) Filed: Jun. 24, 2025

Related U.S. Application Data
(63) Continuation of application No. PCT/CN2022/143290, filed on Dec. 29, 2022.

(51) Int. Cl. G06K 19/077; G06K 19/07

(52) U.S. Cl. CPC G06K 19/07735; G06K 19/0723; G06K 19/07786

(57) ABSTRACT

A radio frequency identification tag assembly is disclosed, including: a conductive radiation medium, the conductive radiation medium including a first portion and a second portion, with a gap between the first portion and the second portion; a thin film antenna, the thin film antenna including a PCB and metal conductive wires extending in different directions from two sides of the PCB; an insulating attachment member spacing apart the conductive radiation medium and the thin film antenna.

### CROSS-REFERENCE TO RELATED APPLICATIONS

This application is a continuing application of PCT International Application No. PCT/CN2022/143290 filed on Dec. 29, 2022. The entire disclosures of the above application are all incorporated herein by reference.

### BACKGROUND OF THE DISCLOSURE

### Technical Field

The present disclosure relates to the field of RFID, and more particularly to a radio frequency identification tag assembly and an object to be identified including the radio frequency identification tag assembly.

### Description of Related Art

The passive RFID technology has the advantages of cost saving and ease of use. When the object to be identified is a building equipment with a curved three-dimensional structure, due to the curved surface of the equipment, it is difficult to attach the RFID tag to the surface of the equipment. At the construction site, thin RFID tags which do not protrude significantly from the surface of the equipment are more desirable. Cylindrical metal support rods are equipment commonly used in the construction maintenance and the support applications, with the high frequency of use, requiring frequent and continuous management. During the use and the transportation of the building equipment, the tags attached to the building equipment must be capable of withstanding the external impacts and the drops. In addition, the tags which protrude with a certain thickness from the curved surface are more susceptible to the physical damages during installation, storage, and transportation of the equipment. Considering the diversity of the curved metal equipment and the difficulty in manufacturing the specialized tags, and the potential exposures to impact, drops, water, and chemical corrosion, there is a need to develop specialized RFID tags with anti-metal, impact-resistant, and chemical-resistant properties.

### SUMMARY OF THE INVENTION

The present disclosure aims to overcome the above-mentioned and/or other problems in the prior art by providing an RFID tag assembly which may attach to the surface of the cylindrical metal object, thereby improving the omnidirectional readability and identification distance performance of the tag.

In a first aspect, the present disclosure provides a radio frequency identification tag assembly. The radio frequency identification tag assembly includes: a conductive radiation medium, the conductive radiation medium including a first portion and a second portion, with a gap between the first portion and the second portion; a thin film antenna, the thin film antenna including a PCB and metal conductive wires which extend in different directions from two sides of the PCB; and an insulating attachment member, the insulating attachment member spacing apart the conductive radiation medium and the thin film antenna.

In a second aspect, the present disclosure provides an object to be identified, wherein the radio frequency identification tag assembly as described above is provided on an outer side of the object to be identified.

The present invention attaches the RFID tag assembly, which is encapsulated with the special material, to the curved metal equipment in a conformal wrapping manner, thereby avoiding the problems caused by the protruding RFID tag assembly when the metal equipment having the curved three-dimensional structure is in use. Under the construction site environment, the equipment may be frequently subjected to the external impacts, drops, collisions, and so on, during the transportation, installation, storage, and loading of the equipment. Therefore, the RFID tag assembly of the present disclosure provides the advantages of the enhanced durability and the extended service life when attached to the metal equipment having the curved three-dimensional structure. At the construction site, it is difficult to realize that the orientation of the antenna of the tag reader is always aligned with the radiation polarization plane of the RFID tag assembly. The RFID tag assembly of the present disclosure enhances the omnidirectional identifiable performance, enabling the RFID tag assembly to be identified not only in all directions but also at relatively distant positions. In addition, in consideration of the harsh application environments, the special encapsulation is employed to improve the durability of the RFID tag assembly.

Other features and aspects become clear through the following detailed descriptions, the accompanying drawings, and the claims.

### BRIEF DESCRIPTION OF THE DRAWINGS

In order to more clearly illustrate the technical solutions in the embodiments of the present disclosure or in the related art, the accompanying drawings required in the description of the embodiments or the related art are briefly described below, in which:

FIG. 1 illustrates a schematic view of an RFID tag assembly attached to the surface of a cylindrical metal equipment.

FIG. 2a illustrates a perspective view and a cross-sectional view of the RFID tag assembly surrounding the surface of the cylindrical metal equipment according to an embodiment of the present disclosure.

FIG. 2b and FIG. 2c respectively illustrate a front view and a rear view of the RFID tag assembly surrounding the surface of the cylindrical metal equipment according to an embodiment of the present disclosure.

FIG. 2d illustrates a rear view of the RFID tag assembly surrounding the surface of the cylindrical metal equipment according to another embodiment of the present disclosure.

FIGS. 3a and 3b respectively illustrate a top view and an exploded side view of the unfolded RFID tag assembly according to an embodiment of the present disclosure. (The symbol T3 shown in the figure is not described.)

FIGS. 4a and 4b illustrate enlarged views of a portion of the PCB 310 of the thin film antenna 300 according to an embodiment of the present disclosure.

FIGS. 5a and 5b respectively illustrate graphs showing the real part and the imaginary part of the input impedance versus the frequency under the open condition and the short-circuit condition at the ends of the conductive radiation medium 400 according to an embodiment of the present disclosure.

FIGS. 6a and 6b respectively illustrate graphs showing the identifiable distance of the RFID tag assembly 200 versus the frequency when the ends of the conductive radiation medium 400 are in the open condition and the short-circuited condition, with the RFID reader rotated at 0°, 90°, and 180° relative to the PCB 310, according to an embodiment of the present disclosure.

FIG. 7 illustrates the radiation pattern of the RFID tag assembly in a plane along the axial direction of the cylindrical metal equipment according to an embodiment of the present disclosure.

### DETAILED DESCRIPTION

In order to make the above objects, features, and advantages of the present disclosure clearer and more understandable, the specific embodiments of the present disclosure are described in detail below with reference to the accompanying drawings.

In the following description, numerous specific details are set forth in order to provide a thorough understanding of the present disclosure. However, the present disclosure may also be implemented in other ways which are different from those described herein. Those skilled in the art may make similar modifications or adaptations without departing from the spirit and the scope of the present disclosure. Therefore, the present disclosure is not limited by the specific embodiments disclosed below.

Unless otherwise defined, the technical terms or the scientific terms used in the claims and the specification shall have the ordinary meaning as understood by those skilled in the art to which the present disclosure pertains. The terms “first”, “second”, and similar terms, as used in the specification and the claims of the present disclosure, do not denote any order, quantity, or importance, but are merely used to distinguish between different components. The terms “a”, “an”, and similar terms, do not imply a limitation on quantity, but indicate the presence of at least one. The terms “comprising”, “including”, and similar terms are intended to mean that the elements or items listed before such terms encompass the elements or items listed thereafter and their equivalents, without excluding other elements or items. The terms “connected”, “coupled”, and similar terms are not limited to the physical or mechanical connections, and are not limited to the direct or indirect connections.

In the present application, unless otherwise specified, all embodiments and preferred embodiments described herein may be combined with each other to form new technical solutions. In the present application, unless otherwise specified, all technical features and preferred features described herein may be combined with each other to form new technical solutions.

In the description of the embodiments of the present application, the term “and/or” is merely used to describe an associative relationship between the associated elements, and means that three relationships may exist. For example, “A and/or B” may refer to: A alone, A and B together, or B alone. In addition, the character “/” as used herein generally indicates an “or” relationship between the elements before and after the character “/”.

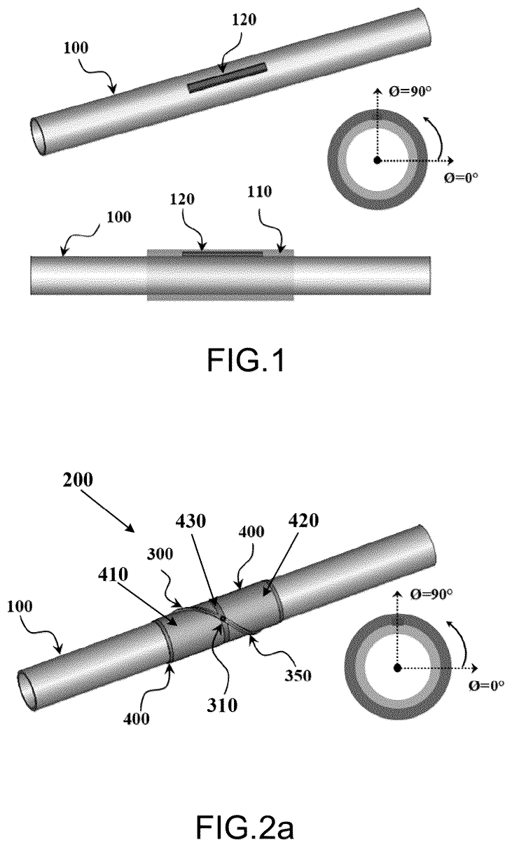

FIG. 1 illustrates an RFID tag assembly attached to the surface of a cylindrical metal equipment. A bracket 110 secures the RFID tag assembly 120 to the surface of the metal equipment 100 in a protruding manner. The metal equipment with such structure may not only be used as the construction equipment but also as a pipeline for transporting oil and gas, a conduit installed in the buildings and the facilities, a power line, an underground conduit for embedding and protecting the communication cables, and so on. Due to the cylindrical structural characteristics and the uneven surface of the metal equipment, when the RFID tag assembly attaches to one side of the cylindrical metal equipment, the grounding surface beneath the tag is in contact with the metal material, making it difficult to maintain the electrical stability. Even with the same tag assembly, the deviations of the performance of the RFID tag assembly may occur depending on the different attachment environments and the usage conditions. In order to attach the tag assembly to the curved surface of the cylindrical metal material, the special brackets that account for the curvature radius or the modified plastic housings adapted for curved attachment are required; however, such approaches increase overall usage costs.

When a small RFID tag assembly attaches to one side of a cylindrical metal equipment, the identification performance, the identification distance, and the identification rate of the RFID tag assembly may change sensitively with the changes in the radius of the cylindrical metal equipment and with the changes in the tag identification angle (ø). When the radius of the cylindrical equipment is relatively large, or when the tag assembly is identified from a direction deviating from or even opposite to the attachment direction, the identifiability is significantly reduced, which severely affects the practicality and the usability of the tag assembly. At the actual construction site, it is almost impossible to arbitrarily adjust the angle of the reading direction of the tag after the equipment has been installed and used. This necessitates aligning the direction of the tag on the equipment with the reader during the equipment is used, which increases the management and labor costs, and reduces the usage efficiency of the RFID tag. Therefore, the electrical performance of the RFID tag shall be configured such that the identification distance of the RFID tag does not change sensitively with the variations in the attachment orientation of the RFID tag. Accordingly, the identification rate in different identification directions (ø changes) relative to the cylindrical metal equipment is an important design factor.

In summary, it is necessary to take into account the aforementioned factors in the application environments to enhance the protection, the durability, and the identifiability of the attached RFID tag assembly.

The present disclosure divides a conductive radiation medium into a first portion and a second portion by a gap, electrically couples the conductive radiation medium to a thin film antenna with a spacing, and disposes the conductive radiation medium and the thin film antenna so as to surround the cylindrical metal equipment with a thickness from the surface of the cylindrical metal equipment. As a result, the present disclosure provides the excellent omnidirectional identifiable performance of the RFID tag assembly. In addition, by arranging a recess in a PCB of the thin film antenna to accommodate the IC chip, and by confining a soldering structure within a surrounding area of the PCB, and by covering the PCB with an encapsulation structure, and by covering the thin film antenna with an insulating layer, the present disclosure protects the RFID tag assembly from the external environmental influences, and improves the durability and the service life of the RFID tag assembly. Moreover, by inclining metal conductive wires of the thin film antenna with respect to the gap of the conductive radiation medium, and by allowing the two ends of the conductive radiation medium to be short-circuited or open, the RFID tag assembly may be adapted to various structures and shapes of the cylindrical metal equipment, while also providing different impedances to achieve the impedance matching between the conductive radiation medium and the thin film antenna.

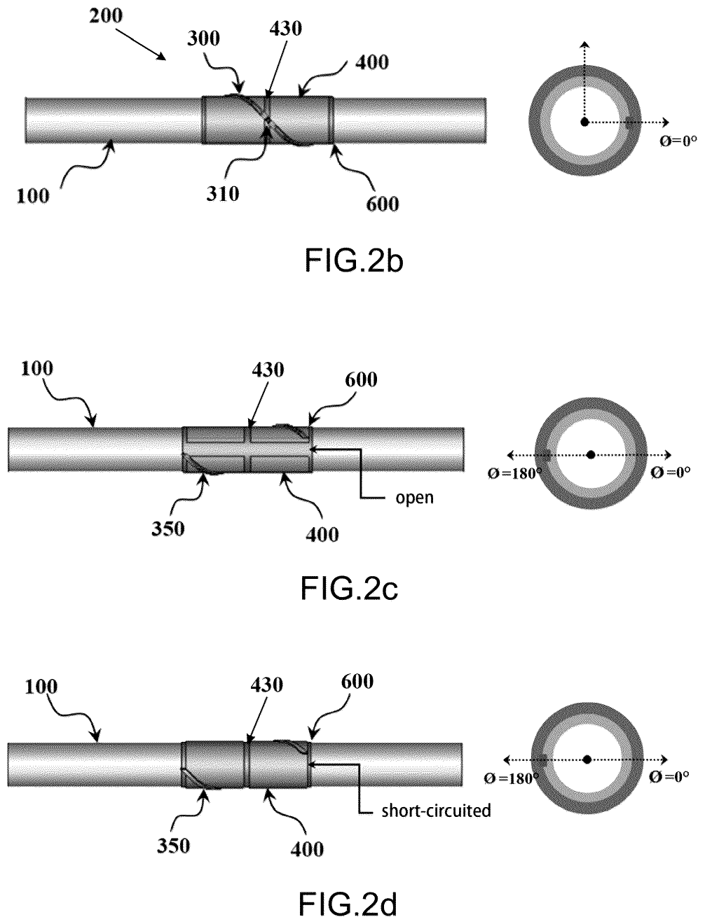

FIG. 2a illustrates a perspective view and a cross-sectional view of the RFID tag assembly which is configured to surround the surface of the cylindrical metal equipment according to an embodiment of the present disclosure. FIGS. 2b and 2c respectively illustrate a front view and a rear view of the RFID tag assembly which is configured to surround the surface of the cylindrical metal equipment according to the embodiment of the present disclosure. FIG. 2d illustrates a rear view of the RFID tag assembly which is configured to surround the surface of the cylindrical metal equipment according to another embodiment of the present disclosure. In the above description, the side on which the printed circuit board (PCB) is mounted is referred to as the front side (as shown in FIG. 2b). The direction aligned with the PCB (namely, the direction perpendicular to the tangential plane of the PCB in the circumferential direction when the RFID tag assembly surrounds the cylindrical metal equipment) is defined as ø=0°. The side opposite to the PCB after the RFID tag assembly surrounds the cylindrical metal equipment is referred to as the back side/the rear side, and the direction toward the rear side (surrounding the circumference of the cylindrical metal equipment, opposite to the ø=0° direction) is defined as ø=180°. It should be understood by those skilled in the art that the terms such as “front side”, “back side”, “rear side”, “front view”, and “rear view” are used merely to indicate the relative positions under a specific configuration, and are not intended to limit to specific directions. It should be understood that, as an exemplary embodiment, the present disclosure illustrates the cylindrical metal equipment; however, those skilled in the art may appreciate that the present disclosure may be widely applied to the equipment having various curved three-dimensional structures.

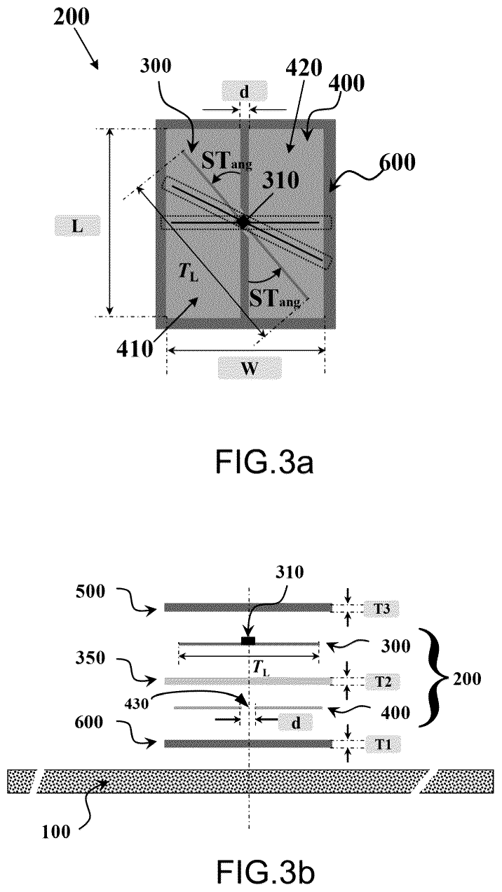

FIGS. 3a and 3b respectively illustrate a top view and an exploded side view of the unfolded RFID tag assembly according to an embodiment of the present disclosure.

In the embodiment of FIGS. 2a to 3b, an RFID tag assembly 200 includes a thin film antenna 300, a conductive radiation medium 400, and an insulating attachment member 350. Moreover, the conductive radiation medium 400 has an area of L×W, and is divided into a first portion 410 and a second portion 420 by a gap 430 which has a width d. Preferably, the gap 430 may be of a linear type, and the first portion 410 and the second portion 420 may have identical shapes. The gap 430 may be formed in other shapes, and the shapes of the first portion 410 and the second portion 420 may also be different. In consideration of the high temperatures that may arise during the final packaging and assembly processes, the RFID tag assembly 200 may be formed by, for example, the thermal compression using materials such as polyester (PET), polyimide (PI), and aluminum foil. Moreover, PET may be used as the bottom surface of the product, while PI may be employed to protect the chip. The thin film antenna 300 includes a PCB 310 and metal conductive wires which extend in different directions from two sides of the PCB 310. An IC chip is included in the PCB 310, and the IC chip is connected to the metal conductive wires on the two sides of the PCB 310. Although the metal conductive wires on the two sides of the PCB 310 are illustrated as having the same length in FIGS. 3a and 3b, it is to be understood that the metal conductive wires on the two sides of the PCB 310 may have different lengths. Optionally, as shown in FIGS. 3a and 3b, the projection of the PCB 310 onto the plane of the conductive radiation medium 400 is aligned with the gap 430, and the metal conductive wires extend above/on the first portion 410 and the second portion 420 of the conductive radiation medium 400, respectively. The length T_{L} of the thin film antenna 300 is determined based on the resonant frequency of the RFID tag assembly 200. The thin film antenna 300 is oriented in a direction within a plane which is parallel to the conductive radiation medium 400. For example, in the embodiment illustrated in FIG. 3a, the thin film antenna 300 is inclined at an angle STang with respect to a direction in which the gap 430 of the conductive radiation medium 400 extends within the plane which is parallel to the conductive radiation medium 400. Optionally, as indicated by the dashed lines in FIG. 3a, the inclination angle STang may be varied, for example, to 90 degrees. This rotational angle STang serves as a design parameter that enables the length T_{L} of the thin film antenna 300 to be adjusted without increasing the size of the RFID tag assembly 200, thereby providing a more uniform radiation pattern and obtaining omnidirectional identifiable performance. Moreover, it is contemplated that the adjustment of the rotation angle STang may provide finer tuning of the impedance without altering other variables of the RFID tag assembly, thereby enabling the impedance matching between the thin film antenna 300 and the conductive radiation medium 400. The film antenna 300 and the conductive radiation medium 400 are electrically coupled to each other across a thickness T2. As shown in FIG. 3b, the separation thickness T2 below the thin film antenna 300 is provided by the insulating attachment member 350 which has the thickness T2. The insulating attachment member 350 may be formed in the shape of an insulating attachment strip. The shape of the insulating attachment member 350 may be larger than the shape of the thin film antenna 300. For example, the edges of the insulating attachment member 350 may surround the edges of the thin film antenna 300, such that the insulating attachment member 350 may support the thin film antenna 300 to prevent the direct contact with the conductive radiation medium 400.

In the RFID tag assembly 200 of the present disclosure, a center of the thin film antenna 300 connected to the PCB, and a center of the conductive radiation medium 400 which is divided into the first portion and the second portion, concentrate the maximum electric field, and substantially serve as a long-distance radiation slot of the RFID tag assembly, independent of the cylindrical metal equipment 100 therein. In the practical application, the combination of the size of the conductive radiation medium 400, the length T_{L} of the thin film antenna 300, and the inclination angle STang of the thin film antenna 300 are the key design variables for achieving the maximum radiation gain and the impedance matching of the RFID tag assembly 200 of the present disclosure.

In FIG. 3b, the conductive radiation medium 400 may be spaced apart from the curved surface of the metal equipment by the thickness T1 through the encapsulation processing, thereby being bonded to the metal equipment. This thickness T1 may be provided by a bottom insulating layer 600, which is typically formed from the insulating strip or the foam resin material. The separation thickness T1 between the RFID tag assembly 200 and the curved surface of the cylindrical metal equipment 100 is an important design variable that determines the identification distance performance of the RFID tag assembly 200 of the present disclosure. As the separation thickness T1 increases, the identification distance of the RFID tag assembly 200 increases accordingly. Although the identification distance of the RFID tag assembly 200 increases as the thickness T1 of the bottom insulating layer 600 increases, the greater thickness T1 of the bottom insulating layer 600 also makes it more difficult for the RFID tag assembly 200 to surround and attach to the cylindrical metal equipment 100. Additionally, it reduces the flexibility of the encapsulation material (such as the bottom insulating layer 600). Therefore, it is necessary to select an appropriate thickness T1 of the bottom insulating layer to improve the tag identification performance of the RFID tag assembly 200 and to facilitate the attachment of the RFID tag assembly 200.

Optionally, as shown in FIG. 3b, a top insulating layer 500 may cover above/on the RFID tag assembly 200. Such top insulating layer 500 above/on the RFID tag assembly 200 may be integrally formed with the bottom insulating layer 600, which spaces apart the RFID tag assembly 200 and the curved surface of the cylindrical metal equipment 100, through the encapsulation process. It should be noted that, in order to clearly illustrate the structure of the RFID tag assembly, the top insulating layer 500 is not explicitly shown in FIGS. 2a to 2d and FIG. 3a. However, those skilled in the art may understand that the top insulating layer 500 may be formed externally on the RFID tag assembly 200 shown in FIGS. 2a to 2d in accordance with the structure illustrated in FIG. 3b. The top insulating layer 500 may protect the RFID tag assembly 200 from the external environmental corrosion, and internally embed the thin film antenna 300, thereby enhancing the protection of the RFID tag assembly 200. In the embodiment of the present disclosure, embedding the RFID tag assembly 200 within a special encapsulation material may improve the durability of the RFID tag assembly against the events such as dropping and impact that may occur during the storage, transportation, and installation of the cylindrical metal equipment.

The structure in which the thin film antenna 300 and the conductive radiation medium 400 are spaced by a certain distance and coupled within the special encapsulation material allows the performance of the RFID tag assembly to not sensitively change due to the errors that may occur during the encapsulation process or the manufacturing process. Moreover, the structure of the RFID tag assembly spaced from the surface of the cylindrical metal equipment 100 by the certain thickness T1 may improve the drawback of the identification performance being sensitively affected by the variations in the radius of the cylindrical metal equipment 100.

Referring now to FIGS. 2a to 2d, FIGS. 2a to 2d illustrate the RFID tag assembly 200, as described with reference to FIGS. 3a to 3b mentioned above, is configured to surround the curved outer surface of the cylindrical metal equipment in the direction in which the gap 430 extends. Namely, when the RFID tag assembly 200 surrounds the cylindrical metal equipment externally, the gap 430 surrounds in the circumferential direction of the cylinder. The thin conductive radiation medium 400 attaches in a curved form to the surface of the cylindrical metal equipment 100 with a thickness. This thickness may be constituted by the bottom insulating layer 600, which is made from a special resin material, and may be formed through an integrally molded process together with the top insulating layer 500. Particularly, when using the special resin material for integrally molded encapsulation (the top insulating layer 500 and the bottom insulating layer 600), UV resin or foam resin materials, which exhibit plastic-like curing properties in response to specific wavelengths of light, may be employed. The thin conductive radiation medium 400 may be attached to the bottom insulating layer 600. In the embodiment of FIGS. 2a to 2d and FIGS. 3a to 3b, the conductive radiation medium 400 is divided into the first portion 410 and the second portion 420, with the gap 430 having a width d between the first portion 410 and the second portion 420. Typically, the resin material encapsulation process requires the processing temperatures of about 70° C. to 75° C. Therefore, the conductive material forming the conductive radiation medium 400 may be selected from aluminum foil, PET material, or high-temperature PI material capable of withstanding such processing temperatures. In FIG. 2c, the ends of the conductive radiation medium 400 are formed to be open on the rear side. In the embodiment shown in FIG. 2d, the ends of the conductive radiation medium 400 are formed to be short-circuited on the rear side (ø=180°). Whether the conductive radiation medium 400 is short-circuited or open depends on the radius of the cylindrical metal equipment 100. Considering the expansion of the radiation slot of the RFID tag assembly 200 or the impedance matching between the conductive radiation medium 400 and the thin film antenna 300 of the RFID tag assembly 200, the ends of the conductive radiation medium 400 may be selected to be short-circuited or open based on the size (the cross-sectional size, the radius) of the cylindrical metal equipment 100 and the corresponding design variables.

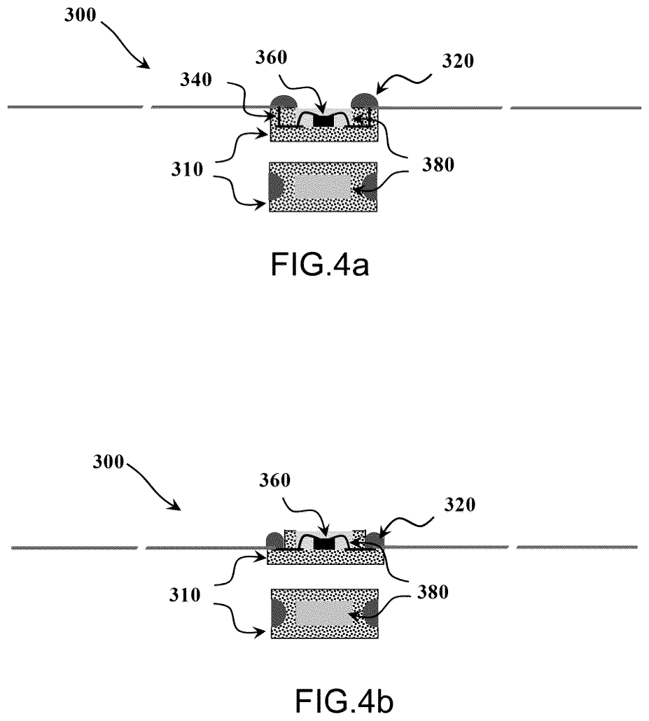

FIGS. 4a to 4b illustrate enlarged views of the portion of the PCB 310 of the thin film antenna 300 according to an embodiment of the present disclosure. In FIG. 4a, the metal conductive wires are soldered together with the PCB 310 on the outer sides of the PCB 310. In the embodiment of FIG. 4b, the soldered portions 320 of the metal conductive wires and the PCB 310 are not exposed outside the periphery (particularly the upper surface) of the PCB 310. Since the RFID tag assembly of the present disclosure is intended for use in the harsh environments, in order to maximize the durability and the service life of the RFID tag assembly, instead of using the ceramic form containing a PCB as in the typical RFID tags, the conductive wire form is electrically coupled with the conductive radiation medium to be used as the RFID tag assembly. Such metal conductive wires connected on the two sides of the PCB 310 may maintain the structure of the RFID tag assembly even under external impacts or drops, and may withstand the high-temperature condition and the high-pressure condition during the special packaging or assembly processes. Such metal conductive wires are surface-treated to facilitate soldering and may be made from metals (such as copper) with various radii. A small PCB block 310 may be selected as the medium for electrically connecting the metal conductive wires to an IC chip 360. In order to further protect the IC chip 360 from the external environment, the PCB 310 may be configured with a recess 380 to accommodate the IC chip 360 and allow for the electrical bonding operations inside. Thereafter, the IC chip 360 is protected from the exposure to the external environment by molding with the epoxy resin.

In FIG. 4a, the length of the metal conductive wires is selected according to the center frequency of the RFID tag assembly 200, and the metal conductive wires are connected to the PCB 310 by being soldered on the left and right sides on the PCB 310, respectively. The IC chip 360, which is arranged within the recess 380, is connected to the external soldered portions 320 via through holes 340 inside the PCB 310. The soldered portions 320, which electrically connects the IC chip 360 to the metal conductive wires, protrudes from the surface of the PCB 310, which presents some drawbacks when using insulating strips for packaging or in environments requiring a thin PCB. In FIG. 4b, the originally protruding soldered portions 320 are accommodated within the periphery of the PCB 310, improving the issue of the soldered portions protruding beyond the edges of the PCB. In some specific use scenarios, by accommodating the soldered portions 320 within the periphery of the PCB, the pressure which is applied during, for example, the final packaging process or the high-pressure application process, which otherwise is concentrated on the protruding part 320, may be dispersed, thereby reducing the risk of the damage.

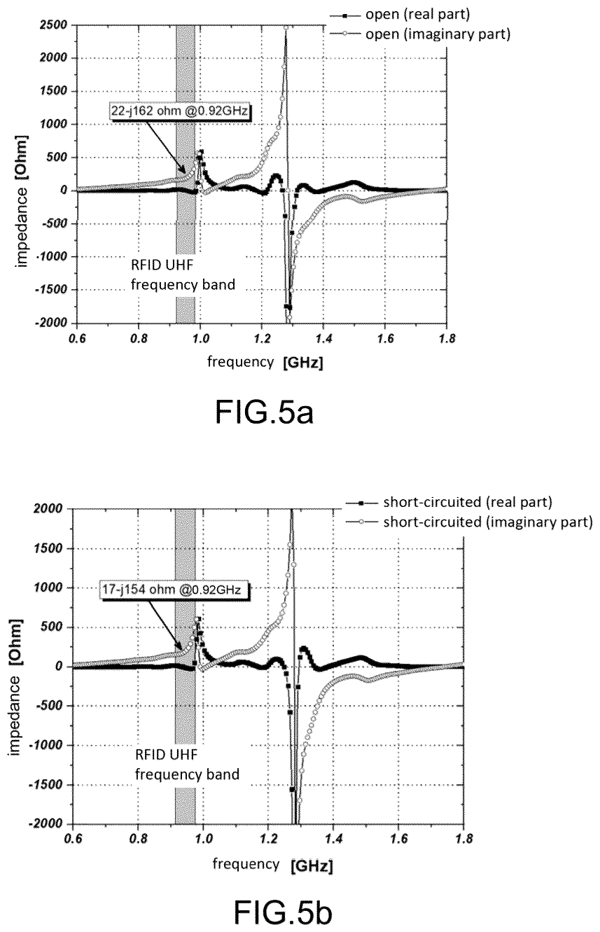

FIGS. 5a and 5b respectively illustrate the variations in the real part and the imaginary part of the input impedance as a function of the frequency, in cases where the ends of the conductive radiation medium 400 of the embodiment of the present disclosure are open (corresponding to the structure of FIG. 2c) and short-circuited (corresponding to the structure of FIG. 2d). It may be seen that the variation of the input impedance as the frequency changes does not significantly change due to whether the ends of the conductive radiation medium 400 are open or short-circuited. Namely, whether the ends of the conductive radiation medium 400 are open or short-circuited has little effect on the trend of the variation of the input impedance as the frequency changes. In FIG. 5a, the input impedance at the center frequency of 0.92 GHz is 22-j162Ω. In FIG. 5b, the input impedance at the center frequency of 0.92 GHz is 17-j154Ω, showing no significant difference. Therefore, under the same other design variables, the open or short-circuited structure at the ends of the conductive radiation medium 400 does not cause sensitive changes in the input impedance or the radiation gain of the RFID tag assembly 200. Consequently, the present disclosure may be widely applied to cylindrical metal equipment structures with various cross-sectional radii.

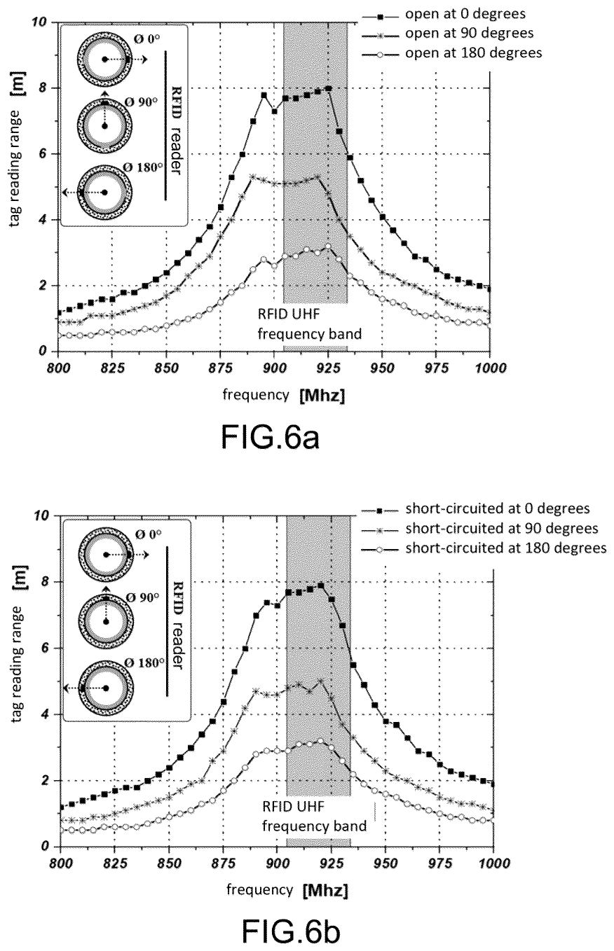

FIGS. 6a and 6b respectively illustrate the variations in the identifiable distance of the RFID tag assembly 200 when the ends of the conductive radiation medium 400 are in the open condition (corresponding to the structure in FIG. 2c) and the short-circuited condition (corresponding to the structure in FIG. 2d), with the RFID reader rotated at 0°, 90°, and 180° relative to the PCB 310, according to an embodiment of the present disclosure. The reading direction of the RFID tag assembly 200 from the front side of the PCB 310 is defined as ø=0°. The reading direction of the RFID tag assembly 200 rotated 90° relative to the front side of the PCB 310 is defined as ø=90°. The reading direction of the RFID tag assembly 200 from the back side of the PCB 310 (namely, the direction shown in FIG. 2c or 2d) is defined as ø=180°. Whether the ends of the conductive radiation medium 400 are open or short-circuited, when reading the RFID tag assembly 200 from the front side of the PCB 310 at the standard power of the reader, the tag identifiable distance is about 7 meters or more, showing excellent readable performance. When ø=90° and ø=180°, the tag identifiable distances decrease to 5 meters and 3 meters, respectively.

In the embodiment of the present disclosure, the conductive radiation medium 400 and the structure of the thin film antenna 300 are electrically coupled with a certain spacing T2, and the strongest electric field is formed at the gap 430 which divides the conductive radiation medium 400 into the first part 410 and the second part 420. Under such configuration, the tag identification distance performance is optimal. Although the identification distance of the RFID tag assembly changes with the rotation angle as shown in the graphs in FIGS. 6a and 6b, the RFID tag assembly may still be identified at the back side (ø=180°). In the practical application environments, the tag identification performance does not sensitively change with the rotation angle of the cylindrical metal equipment.

Moreover, when the length of the metal conductive wires in the thin film antenna 300, the design variables of the conductive radiation medium 400, and the spacing distance T2 between the thin film antenna 300 and the conductive radiation medium 400 remain unchanged, the tag readability performance shows little difference whether the ends of the conductive radiation medium are open or short-circuited. This characteristic ensures that even if the radius of the cylindrical metal equipment changes, the open or short-circuited ends of the conductive radiation medium have minimal impact on the tag readability performance. Therefore, the same RFID tag assembly structure may be widely applied to cylindrical metal equipment of various radii.

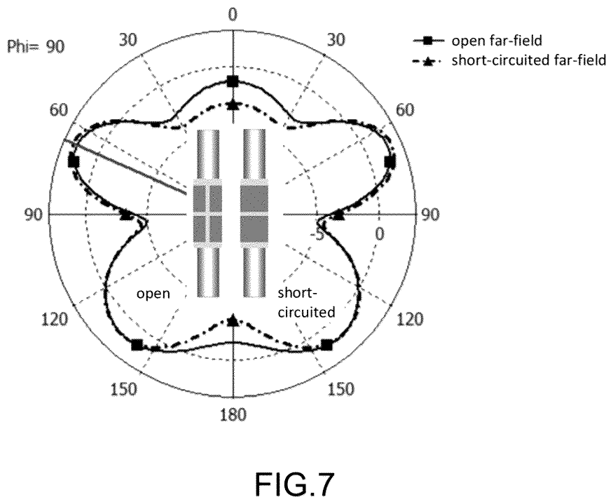

FIG. 7 illustrates the radiation pattern of the RFID tag assembly in a plane along the axial direction of the cylindrical metal equipment according to an embodiment of the present disclosure. In order to compare the performance of the RFID tag assembly 200 in which the ends of the conductive radiation medium are either open or short-circuited at the center frequency of 920 MHz in the UHF band, the radiation patterns of the RFID tag assemblies having the ends open and short-circuited are illustrated together on a unified coordinate axis. Typically, in the RFID tag assemblies operating in the UHF band, the radiation gain becomes concentrated in a specific direction depending on the shape of the ground plane and the attachment position. Accordingly, variations in the antenna directivity and the identification performance may occur depending on the rotation angle during identification. In the present disclosure, by reducing the variation in the identification performance with respect to the rotation angle in the horizontal plane (namely, the circumferential direction) of the cylindrical metal equipment, reliable identification may be achieved easily in the practical application environments without the need for the precise management of the attachment orientation or angle of the tag assembly. In particular, the radiation pattern in the axial direction of the cylindrical metal equipment does not significantly change depending on whether the ends of the conductive radiation medium 400 are open or short-circuited, and similar performance is exhibited in both cases. The identification performance in the axial direction of the cylindrical metal equipment is slightly better in the case where the ends of the conductive radiation medium 400 are open than when the ends of the conductive radiation medium 400 are short-circuited.

It may be seen that: the RFID tag assembly 200 that includes the conductive radiation medium 400 which is divided into the first portion 410 and the second portion 420 by the gap 430, and that includes the conductive radiation medium 400 and the thin film antenna 300 which are electrically coupled with a certain spacing T2, exhibits the feature of the identifiable performance without being sensitive to the changes in the identification angles when the RFID tag assembly 200 surrounds the cylindrical metal equipment.

The conductive radiation medium of the RFID tag assembly of the present disclosure is configured to surround the cylindrical metal equipment with a spacing distance, and is divided into the first portion and the second portion by the gap. When surrounding the cylindrical metal equipment, the ends of the conductive radiation medium may be open. The metal conductive wires of the thin film antenna are arranged above/on the first portion and the second portion of the conductive radiation medium, and the thin film antenna is electrically coupled to the conductive radiation medium with a spacing. Such metal conductive wires themselves may enhance the durability of the structure against external impacts, drops, vibrations, and water ingress.

Moreover, the spaced electrical coupling between the thin film antenna and the conductive radiation medium is encapsulated by a resin material, which finally surrounds the cylindrical metal equipment. Materials that are prone to cracking or fracturing upon impact or dropping are not suitable for use as the encapsulating material. In the present disclosure, the conductive radiation medium and the thin film antenna are embedded and sealed within the resin material, thereby addressing issues of waterproofing and shock resistance, and relatively enhancing the durability of the RFID tag assembly in the harsh construction environments.

In addition, the present disclosure may respectively control and adjust the impedance of the conductive radiation medium and the thin film antenna of the RFID tag assembly to achieve the impedance matching, and control each design variable of the resonant frequency. Accordingly, the present disclosure may be applied to the equipment made of various materials, and the identifiable performance does not change sensitively with the changes in the attachment positions. This coupling structure ensures that the identifiable performance of the RFID tag assembly does not change sensitively due to specific design variables or installation or manufacturing tolerances, thereby improving the product yield during mass production.

The above has described some exemplary embodiments. However, it should be understood that various modifications may be made to the above-described exemplary embodiments without departing from the spirit and the scope of the present disclosure. For example, appropriate results may also be achieved if the described techniques are performed in a different order and/or if the components in the described systems, architectures, equipment, or circuits are combined in a different manner and/or substituted or supplemented with other components or their equivalents. Accordingly, such modified embodiments also fall within the scope of the protection defined by the claims.

What is claimed is:

1. A radio frequency identification tag assembly, characterized in that the radio frequency identification tag assembly comprises:
a conductive radiation medium, the conductive radiation medium comprising a first portion and a second portion, with a gap between the first portion and the second portion;
a thin film antenna, the thin film antenna comprising a PCB and metal conductive wires extending in different directions from two sides of the PCB; and
an insulating attachment member, the insulating attachment member spacing apart the conductive radiation medium and the thin film antenna.

2. The radio frequency identification tag assembly according to claim 1, characterized in that the thin film antenna is positioned such that the PCB is aligned with the gap.

3. The radio frequency identification tag assembly according to claim 1, characterized in that the metal conductive wires extend respectively above the first portion and the second portion of the conductive radiation medium.

4. The radio frequency identification tag assembly according to claim 1, characterized in that an impedance matching between the thin film antenna and the conductive radiation medium is achieved by adjusting lengths of the metal conductive wires on the two sides of the PCB.

5. The radio frequency identification tag assembly according to claim 1, characterized in that the thin film antenna is oriented at an angle with respect to a direction in which the gap extends, in a plane parallel to the conductive radiation medium.

6. The radio frequency identification tag assembly according to claim 1, characterized in that the thin film antenna is attached to the insulating attachment member, and the insulating attachment member is attached to the conductive radiation medium.

7. The radio frequency identification tag assembly according to claim 6, characterized in that a shape of the insulating attachment member is larger than a shape of the thin film antenna.

8. The radio frequency identification tag assembly according to claim 1, characterized in that a recess is formed within the PCB for accommodating an IC chip.

9. The radio frequency identification tag assembly according to claim 8, characterized in that soldered portions of the IC chip and the metal conductive wires are located above a top surface of the PCB.

10. The radio frequency identification tag assembly according to claim 8, characterized in that the PCB further comprises a groove for accommodating soldered portions of the IC chip and the metal conductive wires.

11. The radio frequency identification tag assembly according to claim 1, characterized in that the radio frequency identification tag assembly further comprises a bottom insulating layer and a top insulating layer, wherein the conductive radiation medium, the thin film antenna, and the insulating attachment member are encapsulated between the bottom insulating layer and the top insulating layer.

12. The radio frequency identification tag assembly according to claim 11, characterized in that a material of the bottom insulating layer and the top insulating layer is the same as a material of the insulating attachment member.

13. The radio frequency identification tag assembly according to claim 11, characterized in that the bottom insulating layer and the top insulating layer are integrally formed.

14. An object to be identified, with a radio frequency identification tag assembly provided on an outer side of the object to be identified, characterized in that the radio frequency identification tag assembly comprises:
a conductive radiation medium, the conductive radiation medium comprising a first portion and a second portion, with a gap between the first portion and the second portion;
a thin film antenna, the thin film antenna comprising a PCB and metal conductive wires extending in different directions from two sides of the PCB; and
an insulating attachment member, the insulating attachment member spacing apart the conductive radiation medium and the thin film antenna.

15. The object to be identified according to claim 14, characterized in that the object to be identified comprises a curved three-dimensional structure, and the radio frequency identification tag assembly is configured to surround the curved three-dimensional structure.

16. The object to be identified according to claim 15, characterized in that when the radio frequency identification tag assembly surrounds the object to be identified in a direction in which the gap extends, the first portion and/or the second portion are/is configured to surround at least a part of a cylindrical portion of the object to be identified in a circumferential direction.
